(19) United States
(12) Patent Application Publication
(10) Pub. No.: US 2014/0136935 A1
(43) Pub. Date: May 15, 2014

(54) DIGITAL MEDIA MANAGEMENT SYSTEM AND METHODS OF USE

(71) Applicants: Charis Santillie, San Rafael, CA (US); Donald Lewis Wilson, San Rafael, CA (US); Danielle Cunningham Obregon, New Orleans, LA (US); Sujay Suresh Jaju, Mumbai (IN); Joseph Gregory Miller, Encinitas, CA (US); Pramit Nairi, Santa Monica, CA (US)

(72) Inventors: Charis Santillie, San Rafael, CA (US); Donald Lewis Wilson, San Rafael, CA (US); Danielle Cunningham Obregon, New Orleans, LA (US); Sujay Suresh Jaju, Mumbai (IN); Joseph Gregory Miller, Encinitas, CA (US); Pramit Nairi, Santa Monica, CA (US)

(73) Assignee: CAS DESIGNS GROUP, LP DBA KALEIDOSCOPE, San Rafael, CA (US)

(21) Appl. No.: 14/077,484

(22) Filed: Nov. 12, 2013

Related U.S. Application Data
(60) Provisional application No. 61/725,710, filed on Nov. 13, 2012.

(51) Int. Cl. G06F 17/21

(52) U.S. Cl. CPC G06F 17/212
USPC 715/204

(57) ABSTRACT

The present invention is directed to a system and methods of producing electronic, digital signage that is customizable by a user through a user interface which allows the user to create digital displays specific for the needs of the user's business. In particular, the digital signage system and methods employ a template, modules occupying space within the template, with each module possessing media content displayed in the module and a theme for the template providing a background and coloration for the template. Each module utilizes media content such as a single image or video file, or alternatively, can utilize category content that is comprised of one or more images or video files. To prepare a digital signage advertisement, one or more layouts are combined in sequence and arranged by the user with the schedule, frequency and duration determined automatically or by a user according to the particular needs of the user.

### RELATED APPLICATION

This application claims the benefit of U.S. Patent Application Ser. No. 61/725,710 filed Nov. 13, 2012; the substance of which is incorporated herein in its entirety.

### FIELD OF THE INVENTION

The present invention relates generally to electronic digital signage systems and methods of use. More specifically, the invention relates to digital signage that is programmable allowing a user to select from a variety of media to customize marketing, communication and media entertainment needs.

### BACKGROUND

Digital signage (DS) and electronic forms of media communications are well known in the art of marketing and advertisement. Several patents describe DS-related technology that employs video display systems, a user interface and a server on which to store electronic media. Other DS technology described in the prior art employ internet connections to provide various electronic communications and capabilities. Methods that employ DS technology that facilitate targeted advertising are also well known in the art. Despite the advances in DS technology and digital file manipulation challenges in the use of electronic media for advertising and marketing purposes remain. There yet remains a need in the field of advertising and marketing for a versatile, customizable and easy to use system and method that allows a user to create unique and effective marketing communications directed to and targeting customers most interested in such marketing. The present invention seeks to address this recurring and on-going need.

The use of DS technology and electronic media marketing and advertising has increased exponentially with the increased availability of cheap and inexpensive flat screen technology over the past 5 to 10 years. Effective advertising, to a targeted customer base, is critical to business and DS has become a highly sought option for generating revenue in highly competitive markets. One drawback of current methods employing DS technology to target a desired customer base is that digital signage tools often require a greater amount of development effort to customize and create video and graphics content and integrate this content into real-time data sources. Customizing marketing and advertising thus, requires higher operating costs, necessarily making the return on investment of DS technology platforms less attractive to businesses.

The prior art is replete with systems and methods that seek to capitalize on DS technology to reach customers effectively. For example, “Digital Media Presentation System”, U.S. Patent Publication Number 2005/0086695 to Keele et al., describes a system that provides digital signage advertising employing a video display system. The system includes a server to provide a user interface on which the user may specify a schedule of assets to be executed on video display units. These assets are then displayed in one or more windows of a video display unit. Keele et al., also disclose that assets may be synchronized within the windows and the information of each window may be coordinated to provide display of information through the video display system. The system however, fails to demonstrate customizability of electronic media and the ability to set timing of video displays.

Modern businesses have also recognized the utility of public information displays to also include full motion video content combined with images and text, as well as business logos and such, displayed on high resolution video graphics screens. In general, the process of creating and managing content to be displayed on these video displays has involved using standard graphics and video production tools to produce pre-rendered video clips that are thereafter, played back according to a predefined schedule or play list. United States Patent Publication number 2007/0022382 to Honkaniemi likewise, describes a user interface, apparatus and system that purportedly utilizes internet communications in order to manage digital content. In particular, the document describes a user interface that is based on internet communications, the system including media files arranged to be visible as a thumbnail to establish a playlist created by the media files. The system further includes an “editor” panel that provides three views for a playlist, with each view being individually selectable by a user. The system also purportedly allows users to create and manipulate its content easily for a plurality of presentation terminals via the internet.

In recent years, digital media tools have become available that allow individual content elements such as graphics, animations, and video to be dynamically rendered into a video stream in real-time, without requiring the need for pre-rendering all content into a single video file thus, making editing of digital media easier and more user friendly. As a matter of reference, conventional DS systems employ DVD players or other video playback systems readily available for purchase, to display pre-rendered content. Real-time digital signage systems however often, utilize more advanced computer and video hardware and specialized software to dynamically render content elements on demand. The process of creating real-time data driven graphics for DS typically requires 4 general steps. First, creation of graphical and video elements by a graphics artist. Second, development of custom software applications or scripts by a software programmer to link graphical elements to data sources. Next, distribution of graphical elements and software applications to final play-out locations using either a local or wide area network, or a manual distribution medium such as CD-ROM. Finally, real-time DS systems require monitoring and updating of system elements on a continuing and recurring basis. Accordingly, currently available DS systems require specialized expertise and knowledge that typically preclude the average user and/or business owner.

Typical real-time systems offer the benefit of instantly updating screen content in response to manual, automated triggers or pre-programmed commands input by a user. However, modernly, the typical real-time DS system lacks the ability to customize a signage layout with a variety of media to create marketing and advertising that is custom-fit to a particularized customer base, industry and/or geographic region. United States Patent Publication number 2009/0106082 to Senti et al., describes a “System and method to facilitate targeted advertising”. Specifically, the reference describes a “promotion” scheduler that resides upstream from a subscriber or a group of subscribers that generates a plurality of playlists that provide scheduling information for one or more targeted advertisements.

The media employed can be varied according to the device type located downstream from the promotion scheduler. The playlist defines a pre-constructed set of ads that can be inserted into program content and identified in a given playlist for a specific subscriber or group of subscribers. In the system, subscribers can be grouped by demographic profile and/or by geographic region. Further, target/subscriber attribute data is associated in the system with each of the plurality of schedule files to identify at least one characteristic of an intended target audience of media content represented in each of the plurality of schedule files. The system appears however to be strictly dedicated to identifying targeted subscribers and fails to address the need of providing customizable and easy DS manipulation.

United States Patent Publication number 2008/0263467 to Wilkins discloses a method for automating digital signage applications using intelligent self-configuring objects and so-called smart templates. In particular, the system utilizes existing interfaces such as internet interfaces and employs existing, commercially available graphics programs (i.e., web based tools) or locally run programs (i.e., PowerPoint®) into a digital signage platform to facilitate developing and managing digital signage applications through the creation of smart objects and intelligent templates, described as easy to create and easy to modify to suit different applications. The system therefore, apparently enables DS content to be created without requiring custom programming for each and every stream of new and/or changing content. Likewise, U.S. Patent Publication number 2010/0324997 to Evans describes systems and methods for computer-created advertisements that allow a user to create an advertisement by displaying a plurality of advertising formats for selection by a user, finalizing a proposed advertisement, accomplished by implementing use of the Internet. However, both systems lack the ability to provide a user with easy manipulation of data images including timing of display and touch screen capabilities.

Finally, U.S. Patent Publication number 2011/0288915 to Mochizuki describes a control apparatus for a DS terminal that includes an editing unit and a transmitting unit that utilize point of sales (POS) related data to generate a start command for an event related to article sales promotion. The transmitting unit thereafter transmits to the DS terminal the edited content together with an instruction command for switching a content outputted from the DS terminal from content according to a schedule to the edited content. The device however, lacks the ability to customize specific digital media (i.e., marketing, advertising-related information) according to a desired schedule and order of appearance in order to maximize exposure to targeted and specific customers. Moreover, presently, there is a complete lack of DS technology that allows a user the ability to preview a variety of digital media contained in a content library or to place two or more digital images into a particular digital layout.

Further, the prior art fails to provide the field of digital marketing and its users, the ability to employ use of keyword tagging to pull desired digital images from a content library thus, allowing the system to automatically customize displayed images according to the keyword tagged. It is therefore, a primary object of the present invention to provide an interactive, easy to use and customizable DS technology platform that satisfactorily serves a mass market and effectively targets a desired customer base. It is further an object of the present invention to provide a DS technology system and methods that utilize inputted information, in the form of an extensive content library, readily viewable by a user, to automatically change electronic displays in light of changing customer needs, schedules and evolving products and services.

### SUMMARY OF THE INVENTION

The present invention is directed to a system and methods of producing electronic, digital signage that is customizable by a user through a user interface which allows the user to create digital advertising specific for the needs of the user's business. In particular, the digital signage system and methods employ a template, one or more modules occupying space within the template, with each module possessing media content to be displayed in the module and a theme for the template that provides a background and overall color palette for the template. Each module utilizes either a single image or video file, or alternatively, can utilize category content that is comprised of more than one image or video file, in addition to web feeds from the internet. For example, module types can vary and can utilize text, web feeds, weather feeds as well as other module types employing different types of web feeds. The combination of template, module and theme together are known as a layout for the display created. To prepare a digital signage displays, one or more layouts are combined in sequence within the user interface and arranged by the user with the duration determined automatically or by a user according to the particular needs of the user. The system and methods further employ a computer connected to a server that relays the digital display from the user interface to a monitor, such as for example a flat screen television or other video system appropriate for displaying such media.

According to an aspect of the invention, the method includes receiving customer user input via an internet, web-based connection, to customize one or more layouts in order to create and edit digital signage presentations with a customer user having access to said layouts created by administrative users, the layouts being editable by the customer user according to the needs of the particular customer.

### BRIEF DESCRIPTION OF THE DRAWINGS

FIG. 1 depicts the basic configuration of a layout and modules of the invention. A landscape configured layout is shown with various types of modules assigned therein.

FIG. 2 depicts the basic configuration of the system hardware and software, operating system of the invention. As shown, the invention provides for the use of an interface via an internet website which is linked to a server configured to operate with a Linux operating system to display video images on a video output.

FIG. 3 depicts the basic steps in which a user accesses, prepares and manages a digital presentation of the invention. A customer user accesses his website account and adds or changes media content from a layout, with the layout being sent to a video device for display.

FIG. 4 depicts the aspects of the invention relating to a starting template, a theme and a completed layout. As shown, a theme is added to a blank template together forming a layout

FIG. 5 depicts additional steps in which a user accesses, prepares and manages a digital presentation of the invention. As shown, several layouts (layout sequence) are arranged in order by a customer or administrative user and arranged in the order desired. Users can edit, remove or rearrange layouts, change the transitions of layouts, and set the duration of time in which any particular layout will display during presentation of the layout sequence.

FIG. 6A depicts the ability of a user to view layouts running or scheduled during a specific date range. It further illustrates the ability to insert new layouts into a particular layout sequence and to move/arrange any layout in a sequence according to the needs of the user.

FIG. 6B depicts the ability of a user to search particular layouts employing a keyword search filter.

FIG. 7 depicts properties of a layout. Specifically, a user can change the title, duration of display, assign/schedule dates for display, assign categories for making a search of available layouts, as well as other edits.

FIG. 8 depicts additional properties of a layout and the ability to edit a layout. In particular, the figure illustrates modules contained within a layout. To edit a module and assign content thereto, a user selects the module to be edited that allows the user to select and optionally upload images or other file types, from a content library available for customer users, to the existing module. Web feeds can also be uploaded to modules.

FIG. 9 depicts the ability for a customer user to preview the edits, additions or deletions made to a desired layout prior to its inclusion in a layout sequence.

FIG. 10 depicts the particular types of layouts that are available for editing and inclusion into a layout sequence. Preset layouts, or layouts already containing a full complement of image, text, web feed, weather feed, and/or video files can be selected by a user. Edited layouts are automatically saved for later retrieval and use by the user.

FIG. 11A depicts blank layouts and the ability for a user to populate and edit layouts with files available in a content library according to the user's particular needs. Edited layouts are automatically saved for later retrieval and use by the user.

FIG. 11B depicts the ability for a user to assemble layouts by choosing the backgrounds/themes, and choosing the templates/modules, then populate the layouts with files available in a content library according to the user's particular needs. Edited layouts are automatically saved for later retrieval and use by the user.

FIG. 11C depicts the layouts edited by the user that have been saved for later retrieval and use.

FIG. 12A depicts the content library of the invention. In particular, several file formats are available in the content library from which a user can choose for inclusion in a particular layout. For example, text, video, image or web feed files (e.g., Facebook®, Twitter®) can be uploaded to a particular module which has been assigned to a layout being edited by the user.

FIG. 12B depicts an edit image screen within the content library.

FIG. 12C depicts a modify image screen accessible through the modify button of the edit image screen.

FIG. 13 depicts the content library of the invention. Specifically, the figure illustrates the ability to view files from the content library according to a particular category of files. For example, multiple optional image files relating to animals can be uploaded to a particular module by a user. The images assigned to the module will display in the layout at random when the layout sequence is initiated. Users can add custom content files to the content library if desired which can be included and uploaded to modules of a layout.

FIG. 14 depicts the ability of a user to edit an existing layout. For example, as shown, the template employed illustrates the methods by which the theme and other aspects of the layout can be changed by the user.

FIG. 15 depicts the different types of content files that can be utilized in practicing the invention. For example, image, video and text files, among other file types can be utilized and assigned to modules contained with a particular layout.

FIG. 16 depicts the ability of a user to edit a theme of the digital signage system. For example, the user can change or edit the name of a theme, the type of industry related to the theme as well as a variety of other aspects.

### DETAILED DESCRIPTION OF THE INVENTION

The present invention is directed to a system and methods of producing electronic, digital signage that is customizable by a user through a user interface which allows the user to create digital advertising specific for the needs of the user's business. In particular, the digital signage system and methods employ a template, one or more modules occupying space within the template, with each module being assigned media content by a user to be displayed in the module and a theme for the template that provides a background and overall color palette for the template. Each module utilizes either a single image or video file, or alternatively, can utilize category content that is comprised of one or more image or video files, in addition to web feeds from the internet. For example, module types can vary and can utilize text, web news, and weather feeds as well as other module types employing different types of web feeds. The combination of template, module and theme together are known as a layout for the display or advertisement being created.

To prepare a digital signage displays one or more layouts are combined in sequence within the user interface and arranged by the user with the duration determined automatically or by a user according to the particular needs of the user. The system and methods further employ a computer connected to a server that relays the digital display from the user interface to a monitor, such as for example a flat screen television or other video system appropriate for displaying such media. The digital system also allows a user to preview a layout and/or layout sequence, in real-time, prior to publication on the digital display screen viewer. The preview shows a user how the presentation layout sequence will appear when displayed on the display screen and enables the user to make changes to the layout and/or layout sequence prior to publishing for viewing by a target audience.

In a preferred embodiment of the invention, the system and methods allow a user to customize the media content, duration and sequence of layouts displayed on a video/audio device such as a flat screen television or computer monitor. In yet another embodiment, the media content images will be prepared prior to use in an advertisement or display and stored on a database until the images are uploaded for use, or alternatively, will be prepared by a user on an “as needed” basis in order to further customize the digital display for the user's particular needs. Media types can include images, videos, text and web feeds. For example, weather, news and other real time media content are envisioned herein and encompassed within the scope of the invention.

The invention further provides a layout composed of a combination of a theme, a template and optionally, media content. Further, a layout also provides a user the ability to define the duration and schedule of advertising and media content. The layout is typically a template combined with a theme applied to it, which is assigned media content contained within one or more modules. In the Applicant's administrative user interface, there exist three sub-categories of layout and include, preset layouts, pending layouts and blank layouts. Preset layouts are those layouts possessing modules that have media content assigned to the modules. Pending layouts are layouts in which one or more, but not all, modules have content assigned to them by administrative users. Blank layouts are those layouts that contain modules however those modules have no media content assigned to them.

The invention further provides a template which forms a blue-print of the layout. In particular, the template is a blue print of the layout which is to be displayed on a video display system such as for example, a flat screen television monitor. Optionally, as envisioned herein, the screen employed can be one capable of touch-screen functionality. The template as described herein, defines the aspects of the screen such as orientation (horizontal/landscape, vertical/portrait), placement, position, dimensions and types of modules to be included in the digital display. The templates of the invention are defined and created in XML format with XML the standard language for communications and data transfer. Other standard languages as known in the art are employed to create templates as well.

The invention further provides a module which comprises an area within a template or alternatively, a layout capable of displaying media content. As envisioned herein, each module contained within a template or layout is a fixed type, with types of modules including images, videos, text or web-feed media content. As referred to herein, a fixed type module is defined as a module capable of being assigned only one type of electronic file. For example, a layout is assigned a module which can be assigned only text files. In such a case, this particular module cannot be assigned other file types such as MPEG, audio or other video type files Likewise, once a module is assigned to be a video module, a user is precluded from assigning any text files. Other types of modules, as known in the art, are also within the scope of the invention. Further, modules of the invention can be assigned either a single media content file or more than one in the form of category files. As envisioned herein, a category file can be assigned to a particular module in a layout and will typically contain two or more electronic files which are displayed in the module within the sequence. A category file will contain two or more media files that share common traits. For example, a category file related to baseball will contain two or more media files related to baseball. Once this category file is assigned to a particular module, the media files contained in the category file will display in sequence when the layout is displayed within the layout sequence.

In the instance in which more than one media content file is assigned to a module, the media content is cycled at random to display one media content file, followed by another, and yet another, until the duration of the layout has concluded. In displaying the media content files, the system and method cycle the media files assigned to the module by first displaying the image of picture image 1 in the module. After a designated amount of time has passed, a second picture within the category file is displayed at random. The cycling of images is continued at random with subsequent pictures that are assigned to the category file.

The invention further provides a theme which defines the styling and character that is applied to a template. As envisioned herein, the theme determines the background wall paper for a template, text and background colors, border color and size as well as default font definitions. Other attributes are determined by the theme as well depending on the type of display desired and the industry and field of endeavor of the marketing. For example, a theme of the invention includes attributes of orthodontic dentistry, which are employed by a user of the invention to create and prepare advertising signage related to orthodontic dentistry. Other themes are contemplated and included in the scope of the invention including those not industry or business related.

The invention further provides for content or content media or content media files, which are made up of media (i.e., text, web-feed, images or videos) that are assigned to and displayed within a module. The content can be prepared as a “stock” content to be stored until needed or can include custom content prepared, created and uploaded to the Kaleidoscope website by a user in order to customize advertising according to a user's individual and particular needs. Content will also include dynamic content such as video and periodic streaming updates from the internet such as for example, weather and news updates. Content can also include text feeds and feeds from Facebook®, Twitter® and other websites of the like.

The invention further provides a user the ability to utilize a preset duration for display of various layouts or alternatively, allows the user to customize the duration by which layouts are displayed. Furthermore, the frequency of a layout displaying within the layout sequence can be increased by duplicating a layout to create copies of that layout and placing the copies in various locations of the sequence.

The invention further provides a user the ability to schedule layouts at given times during the calendar year. For example, a user of the invention can set a prepared display related to Christmas to automatically begin in a time period around Christmas (i.e., December 1 to December 25). Display scheduling is not limited to seasonal times however, and includes but is not limited to holidays, events occurring on a yearly basis and personalized events such as anniversaries and birthdays.

The invention further provides a user with the ability to arrange the sequence of the layouts to be displayed. The sequencing capability of the invention further allows a user to rearrange the layout sequence depending on the changing needs of the digital display. For example, a user can prepare a digital signage combination which includes: Layout A, layout B, layout C and layout D. In a preferred embodiment of the invention, the user will also have the ability to later rearrange the layouts according to the changing needs of his business with the layout sequence beginning: Layout B, layout D, layout C and layout A. The layout sequence can be adjusted by either changing the number of the layout within the sequence, or by the ability to “drag and drop” layouts into a different location in the sequence.

The invention further provides a client tool user interface as well as an admin tool user interface. The client tool user interface is a web-based interface, internet and browser-capable computer that is used by customers to create their digital display signage presentations. In another embodiment, the interface can be a touch-screen video display system. The admin client user interface is a web-based interface used by Applicant's support staff which allows the creation and production of “stock” media content, default layouts and other system related aspects of the invention such as for example, user account and subscription management as well as account activity management and accounting reports.

As envisioned herein, the invention provides a user the ability to easily create digital signage utilizing a variety of content media easily manipulated and arranged through a web-based browser to create layouts of a given desirability and geared to the particular needs of the user.

All configurations can be completed via a browser using the internet with setup done online via a regular web browser using the Admin Tool and Client Tool. Further, the invention provides simple and easy user set up and operability, including installation and configuration of the client user interface. The invention allows user content upload of images, videos, text feeds and web feeds to be assigned to one or more modules contained within a layout of the layout sequence with content including dynamic video and streaming files. As envisioned herein, dynamic content includes for example, weather, news feeds, among other updated information available on the internet. The invention further provides a user with multiple format layouts allowing the user the ability to employ different layout types for different entertainment and business-related purposes. For example, layouts related to orthodontic dentistry can be employed to create advertisements pertaining to a user's orthodontic dentistry practice.

The invention further utilizes layouts that can display different media and content formats to be displayed in a single layout. As envisioned herein, templates will also be editable by a user. In this embodiment, a theme will be added by the user prior to being assigned to a layout and/or layout sequence. In addition, layouts can utilize modules that are dynamic, providing viewers of the display with continually updating information related to news, weather, other web feeds chosen by the user, and other details related to the user's business. Layouts as described herein provide a user the ability to employ use of different media types within a layout. For example, a layout can employ a video file in one module, while in another module, a JPEG or image file can be assigned therein, with all modules viewable simultaneous on a particular layout. New templates can be added on an “as needed” basis in order to expand or edit the user's changing business needs without the need of creating an entirely new layout sequence. As envisioned herein, templates will be created and stored on a database or will be created “on the fly” by and utilized by a user according to his or her own particular needs.

Further, the invention provides a user the ability to utilize previously prepared templates, layouts and content and edit them as appropriate. Also provided in the invention is the ability to customize scheduling of prepared layouts. To that end, layouts can be scheduled and sequenced, rearranged and edited as needed in order to customize for the purposes of the particular business involved with the digital display being created. In yet another embodiment envisioned herein, the invention will be able to provide the user with an online preview of the layout so that the sequence layout can be viewed in real-time prior to publication to the digital video imaging system.

A preferred embodiment of the invention provides a user with a web-based user interface which includes a computer terminal with access to the internet and a computer operating systems, such as a Windows® or Apple® based operating system or other like operating system and a subscription to the Applicant's web site in which a user name and password is employed. In the preferred embodiment, the user is able to access a database of stored layouts that can be used “as is” or can be edited to suit the user's needs to create customized advertising and marketing layout sequences that are particularized for the needs of the user's business needs. An aspect of the invention also allows a user to schedule prepared layouts according to the user's preferences. For example, the user can schedule a particular layout related to American Independence, on or near July 4.

In yet another embodiment of the invention an administrative user and/or client user can prepare customized layouts that are available for editing in the system invention software and website. An admin user is able to edit and assign borders, text font and colors. In a preferred embodiment, one or more modules is assigned to a Preset or Blank template, with layouts being populated with modules that can be assigned specific media content (i.e., content), that include image files, video files or other files as appropriate for the digital display. In assigning modules with content, in most cases, more than one content file can be assigned to a particular module simultaneously if desired. For example, 50 image files, in a category file, can be assigned by a user to one particular module with each image file showed at random in that module. In the embodiment, an initial image file is shown in the module, with the image being replaced by another image in the category, and so on until the duration of the layout has concluded.

In another preferred embodiment of the invention, a user can select a layout that is specific for the field or other event type in which the user wishes to advertise. For example, an orthodontist can select a layout related to orthodontic dentistry among a number of other layouts related to other fields of endeavor. Layouts also include themes that are not business or industry related. In such a case customer users can select layouts that are non-industry related such as for example, layouts related to animals or particular scenarios. The user can thereafter edit the layout according to the user's particular business or non-business needs. An aspect of the invention is to allow a user to input key words, in the form of “keyword tagging” in order to search and locate the most appropriate groups or categories to select for the user's particular needs. Keyword tagging includes the use of drop down menus to select from groups and categories of media content that can be assigned to modules.

In a preferred embodiment, the system and methods utilize XML, XSLT or JSON communication and data transfer language to create and manage layouts produced by an administrative user. Content is assigned by the user via an online application/interface after XML, XSLT or JSON is employed to incorporate the system and layout. The user selects a module and then selects from a library of images, videos, text feeds, or newsfeeds to apply to that module. An aspect of the invention includes modules that are “fixed” in that each module is assigned to a particular file format. For example, a module in a layout sequence can only be assigned one media type such as for instance, image files. In this scenario, the fixed module can be assigned more than one image file, which will all be displayed in random rotation. In another scenario, a module can be assigned one or more video files. In this scenario, the module will be assigned video files only (i.e., no image, streaming or other type files). In the instance in which more than one video file is assigned to the module, each video file will be displayed at random, one after the other, until that layout's duration has expired.

The term “template” and the like as used herein refers to a skeleton, blue print of the layout of the invention that is displayed on a video device such as for example, a flat screen television screen or computer monitor. The template defines aspects of the layout such as orientation (horizontal/landscape, vertical/portrait), the placement thereof and types of modules that are assigned to the layout. The templates are defined in format using XML as a standard language for communication and data transfer acting similarly to HTML however, other formats are envisioned and known in the art and are likewise envisioned within the scope of the invention. As envisioned herein, the template will employ other computer language and formats in order to define templates of the invention.

A preferred embodiment of the invention includes the use of a Linux® based operating system in order to operate the invention application through user interface access ports. The computer system of the invention communicates with a storage server containing available media content and other software necessary to operate the invention using a SOAP based API, over HTTP. The computer system of the invention further utilizes standard language calls to detect network connections which encompass a portion of the Linux code base. The online application is installed as a native application while the preview or user interface is operated within the Flash plug-in stored on the server of the invention. Both employ the same SOAP based API, over HTTP.

In a preferred embodiment the XSL converts the XML into a visual format—for ease of verifying what is created. The CMS layout development utilizes symphony framework.

The term “subscriber”, “subscriber user”, “customer user” and similar terms, refer to an individual who has subscribed to the administrative client's website and whom has been provided with a user name and password in which to access the administrative client's database of information including but not limited to layouts and content files.

The term “administrative client”, “administrative client user”, “administrative user” and like terms used herein, refer to individuals who work in the capacity of the Applicant's corporate entity. For example, programmers, support staff and technical representatives encompass part of the administrative client. The administrative client provides stock and general templates, layouts and content to be used by subscriber users on an as-needed basis.

The term “module” and the like as used herein refers to an area within a template or a layout where content, content media or the like can be displayed. Each module of the invention has a fixed type of file format associated with it. Types of modules include but are not limited to, image, video files, text or web-feed files including streaming information from such sources as for example, weather, news, stocks and the like or other dynamic media feeds streamed from the internet. Modules can be assigned a variety of file formats including JPEG, GIF, PNG for images, MP4, FLV for video files and RSS, Twitter®, Facebook® XML web feeds.

The term “theme” and the like as used herein refers to the particular styling that is applied to a template. The theme determines for example, the background wallpaper for a layout, text and background colors, border colors and size, and font definitions. The theme associated with a layout can also include aspects of particular fields of endeavor as well. For example, the theme assigned to a template or layout can have aspects and elements associated with orthodontic dentistry such as images of braces, teeth, dental instruments and the like.

The term “content”, “media content”, “content file” and the like as used herein, refers to a piece of media such as for example, text files, web-feed streaming, scrolling text feeds, image and video files. The content envisioned in the present invention also includes but is not limited to dynamic streaming text and images from internet sources to provide news, weather, sports and stocks updates for example. Image files can include but are not limited to JPEG, TIFF and other like file formats. Content can be assigned to particular modules from various sources as well. For example, content can be generated, created, and uploaded by a subscriber user independently Likewise, a subscriber user can assign content which is provided by the Administrative Client user which is content created and stored on a database until needed by a subscriber user. Content can also be designated into industry-specific content in which specific, similar content is designated for certain industries. For example, content related to dentistry is provided separately from content related to dermatology into separate content categories.

The term “customer user interface” and the like as used herein, refers to a device or item that allows a user subscriber (i.e., customer subscriber with an online user name and password), to access the digital system website. A customer user interface can include for example, a personal computer, that is linked to the Internet and which can access the digital system website to create digital presentations.

The term “administrative user interface” and the like as used herein, refers to a device or item that allows an administrative user to access the digital signage website so to, for example, create new layouts (i.e, blank, preset, etc.), modules, layout sequences, as well as any other aspects of the digital signage computer programs of the invention. An administrative user interface can include for example, a personal computer that is used by administrative users.

The term “category” or the like as used herein refers to content media files that are similar or like to one another. For example, a category of media content can include for example, “animals”, “landscapes”, “sports” and “people”. Other categories are contemplated herein and are within the scope of the invention.

The term “filter” and the like as used herein refers the ability of a user to input desired search terms into the digital signage system whereupon the system will provide media content that is most related to the user's desired search terms. For example, a user can enter the term “animals” to search for layouts that are related to animals.

The term “customer user input” and the like as used herein, refers to information, content files or other information which a customer user enters into the digital signage system to prepare a digital signage presentation. For example, customer user input can include but is not limited to content media files such as images, video files or the like.

The term “content library” and similar terms thereof, refers to a database containing prepared media to be viewed and utilized by user subscribers in order to create and manage digital signage, layouts, and layout sequence. For example, Applicant administration prepared content, such as image files, video files and the like, stores the files in a database which may be accessed by user subscribers. The content library as envisioned herein is viewable by user subscribers and each file contained in the content library can be accessed by the user subscriber allowing the user subscriber the ability to assign the media content to layouts in their own particular layout sequence. Also envisioned within the scope of the present invention is the ability for a user subscriber to import and add content generated by the user subscriber to be used in layouts to be created in the future and incorporated into their layout sequence.

The term “layout” and the like as used herein, refers to the combination of a template, a theme and optionally content, which together form the layout of a display of the invention. A layout can be assigned particular duration and scheduling in the manner in which the layouts are displayed. For example, a layout may be assigned by a user to display on particular dates and also scheduled to repeat yearly if so desired. The layout can also be assigned by a user to be displayed during particular times of the year including for example, Christmas for advertisements relating to holiday shopping. The user can choose from four types of layouts including Preset layouts, Blank layouts, Custom layouts, and layouts previously edited by the user. A Preset layout is one in which all modules assigned to the layout have content assigned to them. Blank layout is one in which none of the modules in the layout have been assigned content. Custom layouts can be created by the user such that they can assign a particular theme to a particular template. There is also a category of layouts that includes all layouts previously edited by the user.

The term “layout sequence” and the like as used herein, refers to a combination of prepared layouts which are arranged in order by a user. The term can also be used interchangeably with the term “digital signage presentation”, or “digital signage display”. For example, a user can prepare a layout sequence digital signage display containing 100 layouts. The layout sequence would be defined by the order in which each layout was placed in the digital signage display. (i.e., layout #1 through layout #100). As envisioned herein, the system and methods allows a user to create a layout sequence with as many layouts as desired.

The term “duration” as used herein, refers to a period of time for which a layout remains displayed on a video display screen. The term refers to the duration on which the digital signage layout is shown on a screen. The duration can be assigned by a user or can be set by a default duration for a layout can be assigned in creating digital signage presentations.

The term “module sequence” and the like as used herein, refers to the order in which electronic files assigned to a module are displayed in a particular layout. For example, a user can assign 100 image files to a single particular module of a layout. The module sequence refers to the order in which those 100 images files cycle through the module. As envisioned herein, the images assigned to a particular module will display in the module at random. The duration of a module display is pre-determined by administrative users who set the display duration for modules to a standard length of time and is applied to all image modules. For mixed media content (images+text), the sequence is scrolled at an admin controlled pace within the module after randomized sequencing.

The term “client tool”, “customer tool” and the like as used herein, refers to the user, subscriber interface used by an individual accessing the system of the present invention. The client tool is a web-based interface where the user/subscriber can login to set up and modify a layout sequence or desired layout using desired content and preferences in which to create the layout(s).

The term “admin tool”, “administrator tool”, “administrative tool” and the like as used herein, refers to a web-based interface used by Applicant's staff and technical team to setup generic and “in-house” stock templates, content, default layouts and the like to be used by user, subscribers to the system invention on an as-needed basis. The term “admin tool” and similar terms refer to the computer interface used by individuals who provide customer support for Applicant's company and whom work in the company's interests of creating and managing the system invention for subscribing customer users.

The term “media PC” as used herein, refers to the computer processing platform on which the elements of the invention are communicated to subscriber users to prepare layout sequences. (i.e., templates, layouts, modules, content, etc.) The media PC processes the data to be utilized by user subscribers to create a digital signage layout sequence for purposes of advertising and/or marketing and entertainment. The media PC employs standard internet language including but not limited to XML and Flash to create aspects of the invention. The media PC also acts to relay the digital signage layout sequence to a digital video display such as for example, a flat screen television screen or computer monitor.

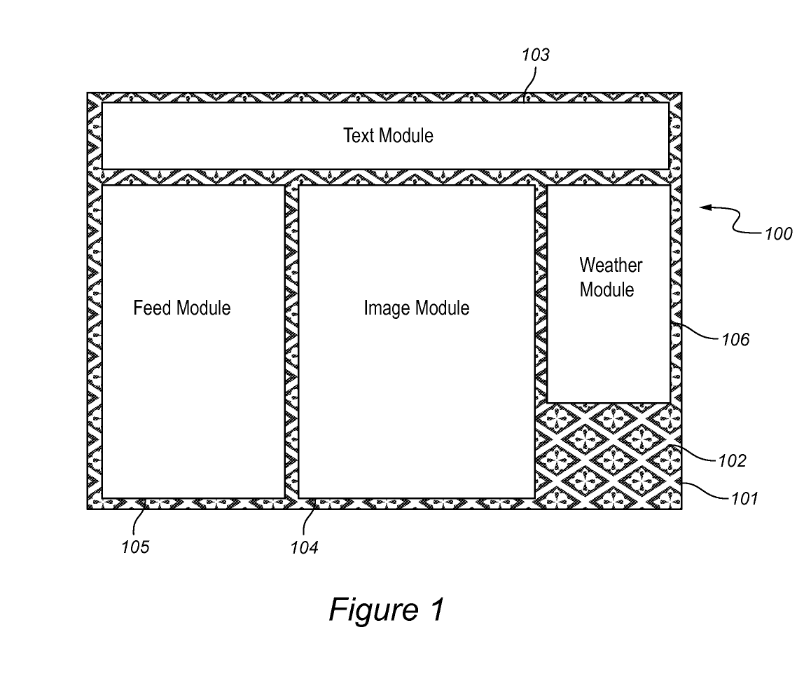

Turning now to the substance of FIGS. 1 to 16 and the preferred embodiments of the system and methods of the present invention.

FIG. 1 illustrates a layout of the invention 100. As shown, the layout includes several types of modules including a web feed module 105, an image module 104, a text module 103 and a weather feed module 106. The figure further provides a template 101 and a theme 102 for the layout.

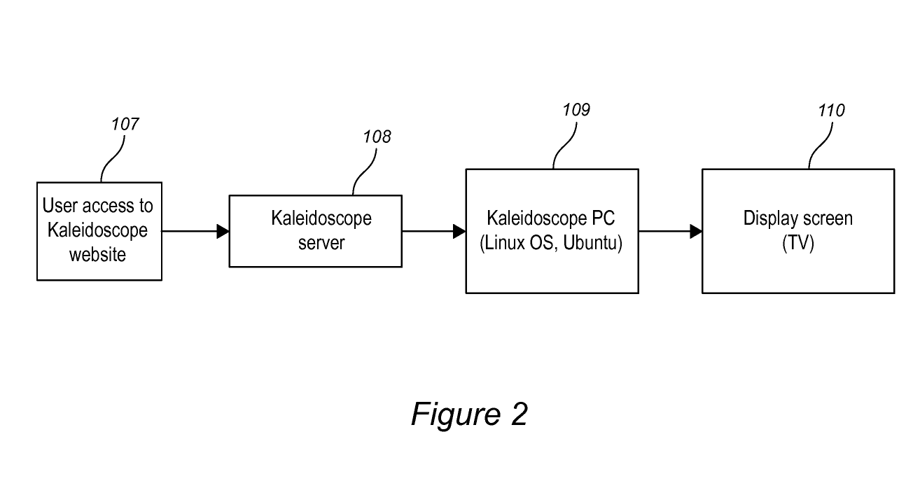

FIG. 2 illustrates the process by which a user accesses the digital signage system to create a layout or layout sequence. As shown, a user accesses the internet website via a web based interface 107. Input from the user is linked to a server 108 which is further linked and configured to a computer with a Linux operating system or Ubuntu program system 109, wherein the Kaleidoscope PC 109 calls for data from the Kaleidoscope Server 108 and pulls the requested data, as needed. Input is then displayed on a display screen monitor 110.

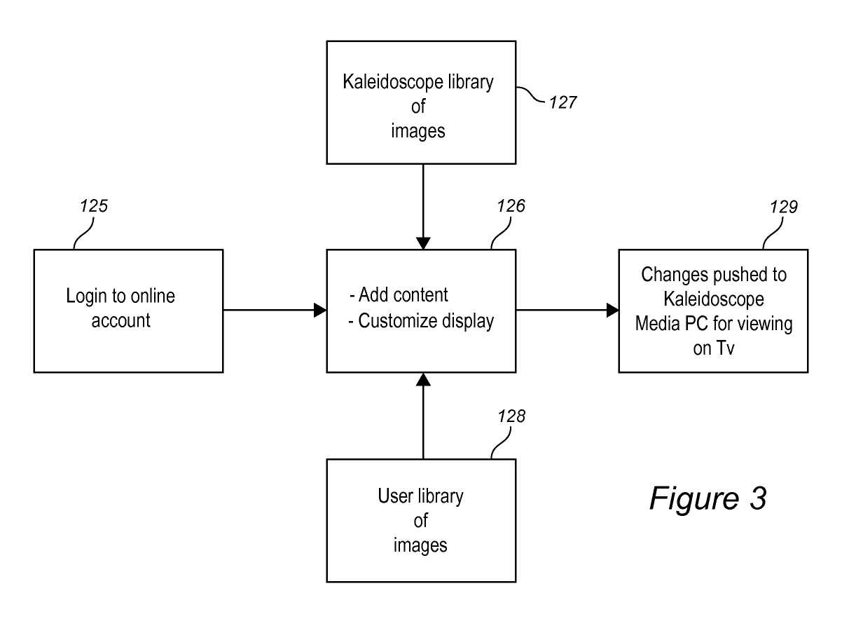

FIG. 3 illustrates a basic configuration of the digital signage system. Specifically, a user accesses the system website by logging into an online account 125. The user can then access media content from the website system library of images 127, for example, and can also include videos, internet feeds, weather feeds, text input and changes and the like. The user can also create a library of the user's own media content 128 for use in creating a digital signage presentation. Media from both the system website and the user media content is used to add content to the layout/layout sequence and to customize the digital signage presentation 126. The layout or layout sequence is then pulled from the Kaleidoscope Server 108 to the system website computer 109 where the layout or layout sequence is sent to a television, flat screen monitor, or other appropriate video display 129.

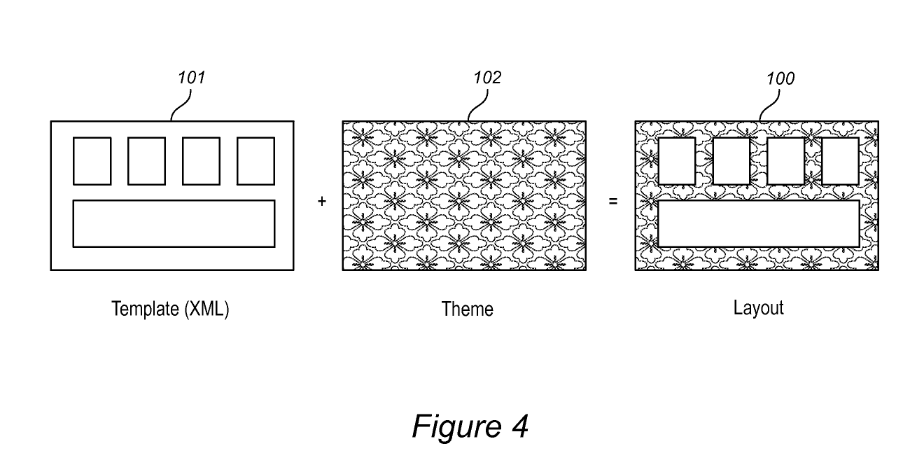

FIG. 4 illustrates the different aspects of a template, a theme and a layout of the invention. The website system includes a template 101 which is the starting point in the process of creating a layout. A theme is provided 102 that include colors, designs or other characteristics that are added to a template. Once a theme is added to a template, the combination thereof is a layout 100.

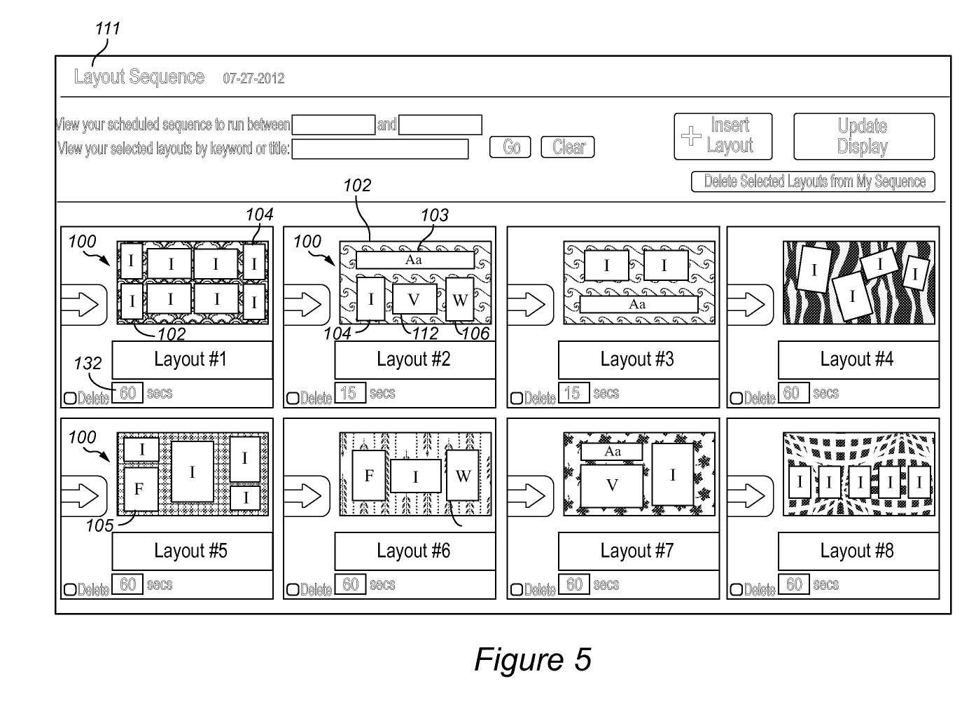

FIG. 5 illustrates a layout sequence 111 of the digital signage system claimed herein. As shown, several layouts have been created 100 and are displayed by the signage system in order of appearance in the layout sequence. The figure provides an image module 104 in a layout populated with a theme 102. Each layout is programmed by a user to display for a desired amount of time in a numerical identifier 132. Similar layouts (i.e., Layouts #2 through #8) are further provided. The website system provides a user buttons to insert new layouts and to update the layout sequence as well as entries in which dates can be entered on which to display the layout sequence.

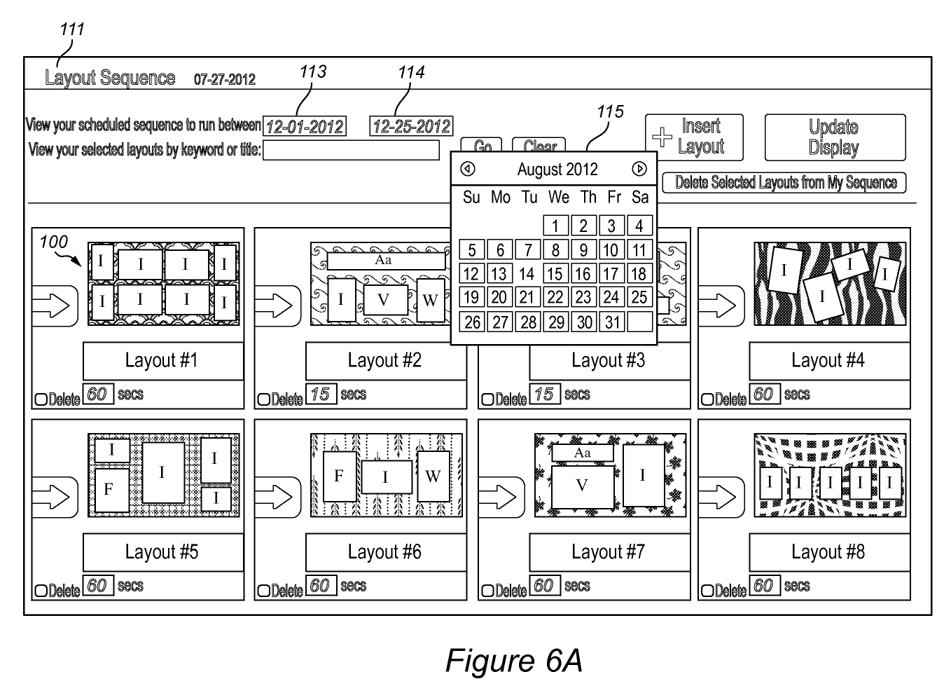

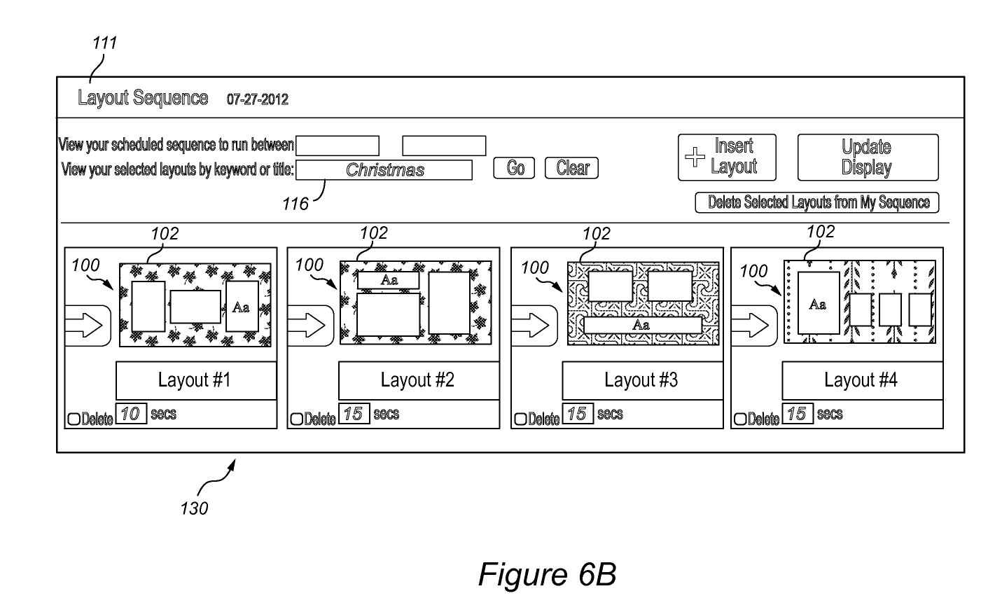

FIG. 6A illustrates a layout sequence as described in above in FIG. 5 111. As described and shown, a user can select desired dates to filter and view the layouts that will be actively running on the television or flat screen display device during that date range. For example, a user can filter and view the layouts that will be actively running on the display from date 113 through date 114. In addition, a user can make limited changes to the layout sequence, including deleting a given layout, editing the transition of a given layout, reordering layouts by dragging and dropping them into an alternative order and changing the duration in seconds that a layout will be displayed.

FIG. 6B illustrates another preferred embodiment of the layout sequence of the claimed invention 111. Specifically, the figure illustrates a layout sequence made up of similarly themed layouts 130. For each layout 100 included in the sequence, the layout is populated with a specific theme 102 according to the user's needs in creating the digital signage presentation and layout sequence.

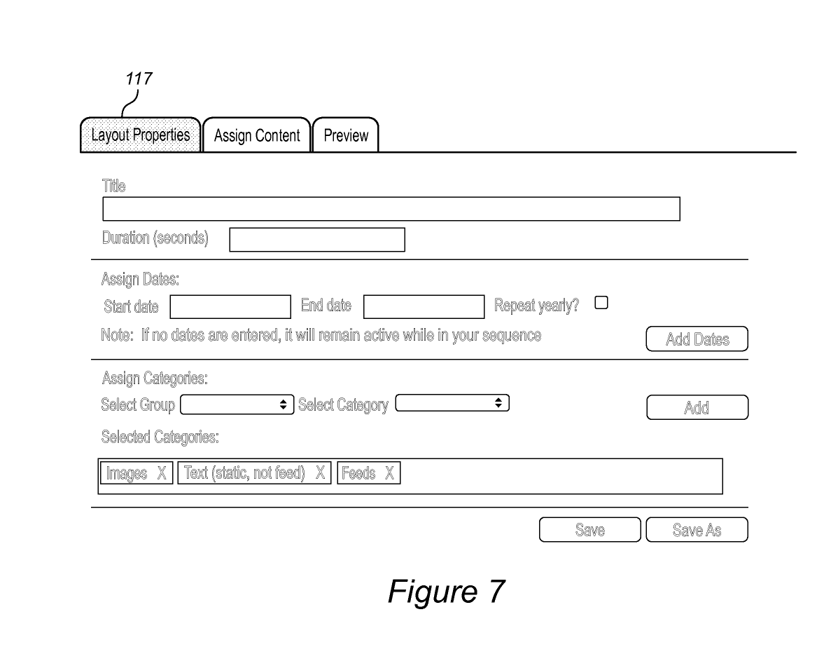

FIG. 7 illustrates the ability of a user to designate desired properties and characteristics to the layout created. As shown, a tab on the website system 117 is selected by a user after which the user can input specific information to be designated to a particular layout. Title, duration of display, starting and ending dates, as well as other characteristics can also be input for display.

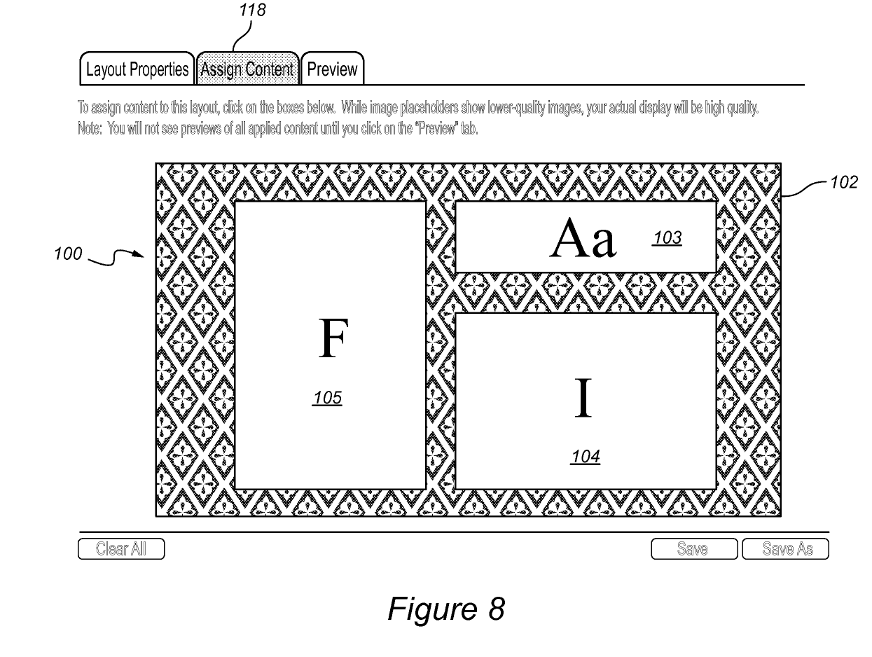

FIG. 8 illustrates the ability of a user to assign media content to one or more modules of the invention. As shown, a tab on the website system 118 is selected by a user after which the user can assign specific pre-existing media to a particular module that is populated within a layout 100 that is assigned a particular theme 102. For example, text 103 can be assigned and optionally input into a module, an image file can be assigned to another module 104 while a feed source from the internet can be assigned to a web feed module 105. The designation and assigned modules can then be saved for use. Additionally, and as an alternative to reliance on content libraries, the user can create his/her own new media content and then upload that content directly through the assign content tab.

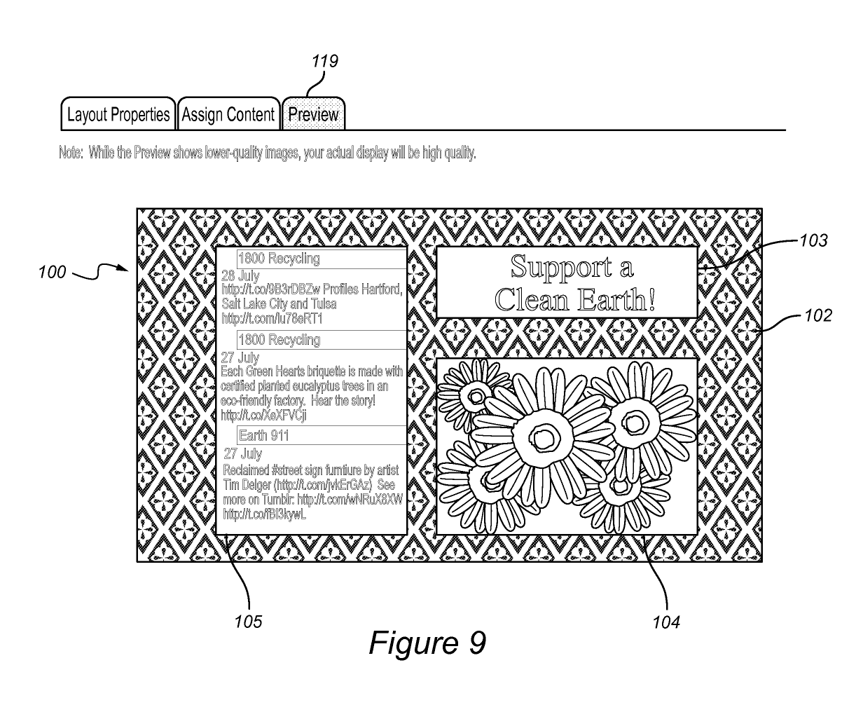

FIG. 9 illustrates the ability of a user to preview a prepared module of the invention. As shown, a tab on the website system 119 is selected by a user after which the user can preview a layout of the invention 100. For example, a module containing text 103 is provided. Also provided is a module that has been assigned an image file 104 of flowers. Also, a module that has been assigned a web feed source relating to an on-going schedule of events 105 is provided. To create a layout, a user selects pre-existing media content and thereafter assigns the content to each module.

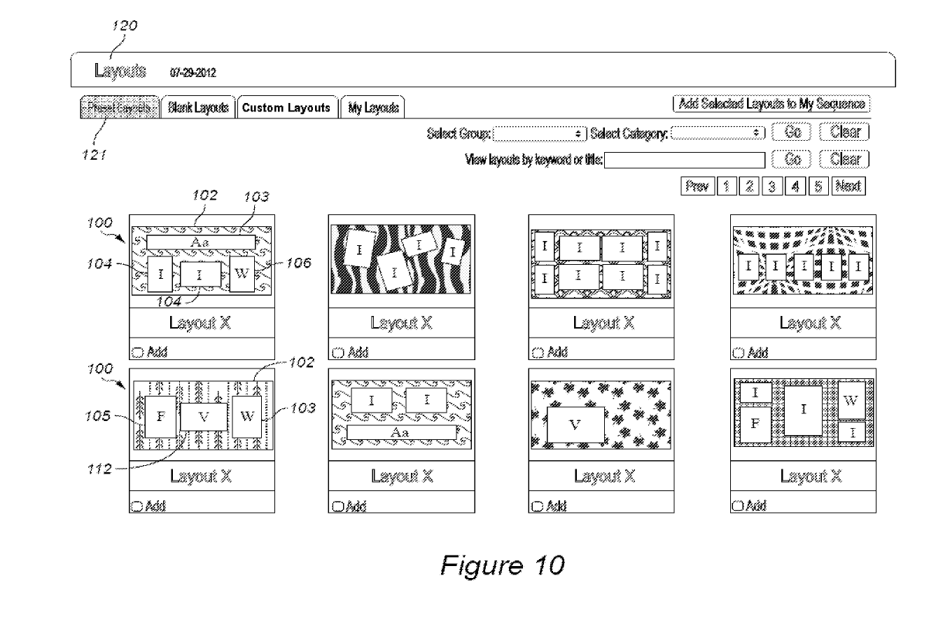

FIG. 10 illustrates a section of the digital signage system that provides a user the ability to select pre-existing layouts that can be employed in creating customized layout sequences. As shown, the figure provides a button for preset layouts 121 on the layouts page 120 of the website system which when selected provides the user with a choice of pre-existing layouts that can be further edited and customized according to the user's needs. In the illustration various module types are assigned to the modules in each layout. For example, a text module 103, a weather feed module 106, an image file 104 and a video file 112 has been assigned to various modules. Subsequently, each layout can be arranged by a user in a desired sequence in the layout sequence page.

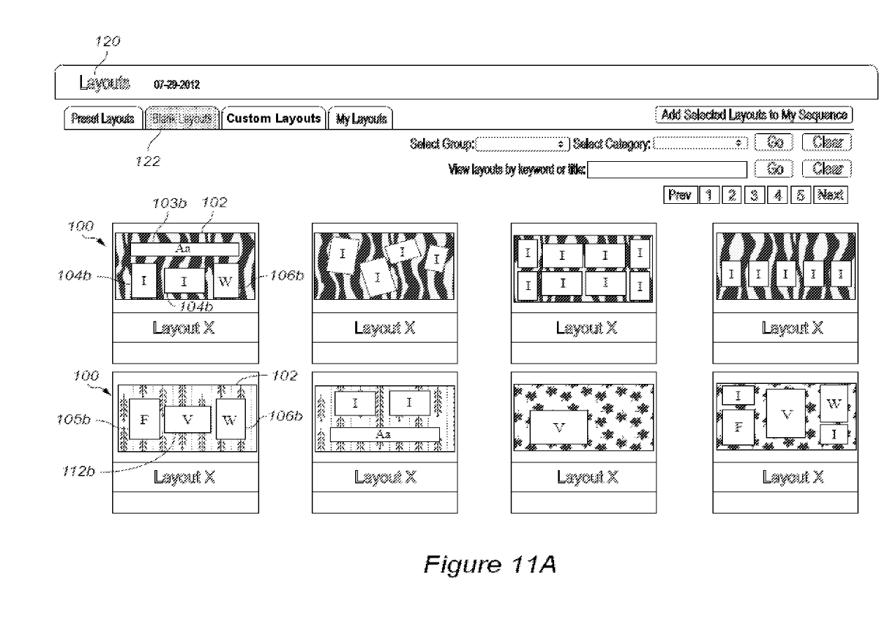

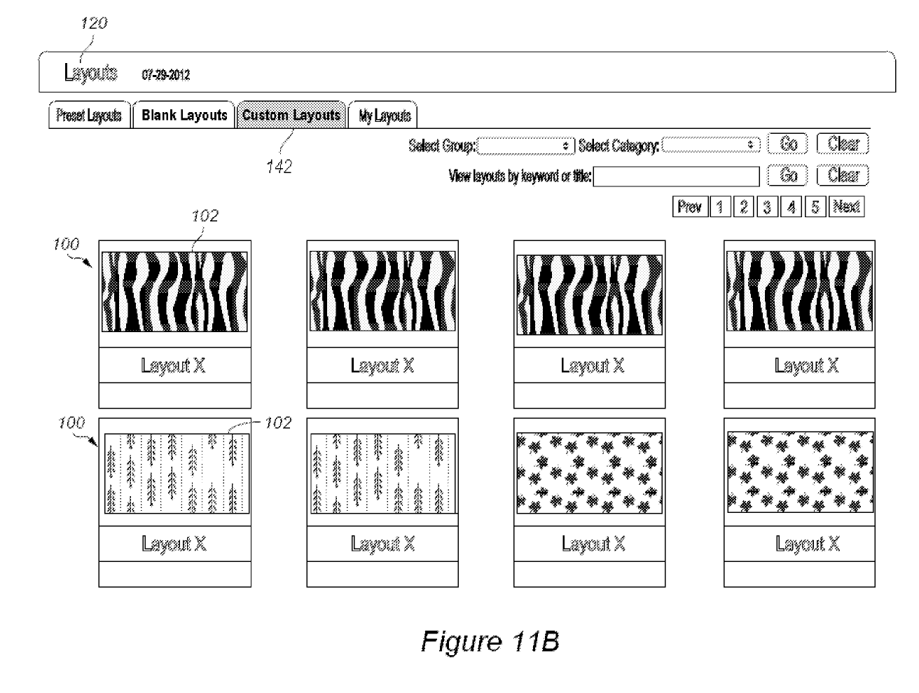

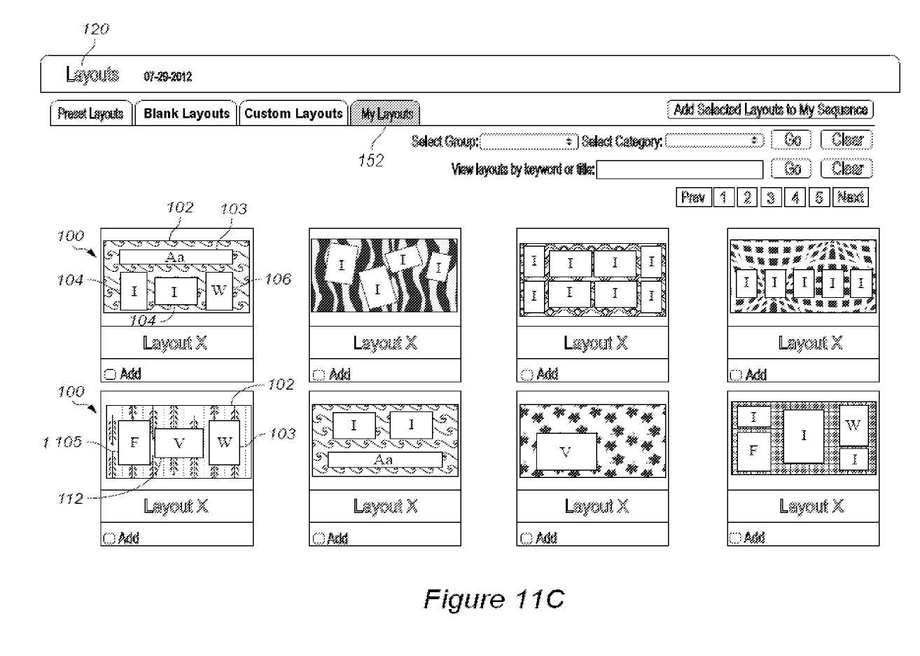

FIG. 11A is another section of the digital signage system of the invention that provides a user the ability to select layouts and layout sequences that have no media content assigned to them (i.e., blank layout) thus, providing the user the ability to assigned custom created media to modules of the blank layout. As shown, the figure provides a button that can be selected that allows a user access to blank layouts 122 on the layouts section of the digital signage system 120. Thereafter, the user can assign media content such as image files 104b, weather feeds 106b or other feed media types 105b to the modules of the blank layout.

FIG. 11B shows the screen corresponding to the “Custom Layouts” tab in between the “Blank Layouts” and “My Layouts” tabs. The “Custom Layouts” screen only shows the backgrounds/themes without the modules overlaid thereon. Once the background/theme is selected, then the user will complete the custom layout design by choosing what modules will be applied, and then apply content accordingly.

FIG. 11C shows the screen corresponding to the “My Layouts” tab. The “My Layouts” screen looks similar to the “Preset Layouts” screen, however it only shows layouts edited by the customer.

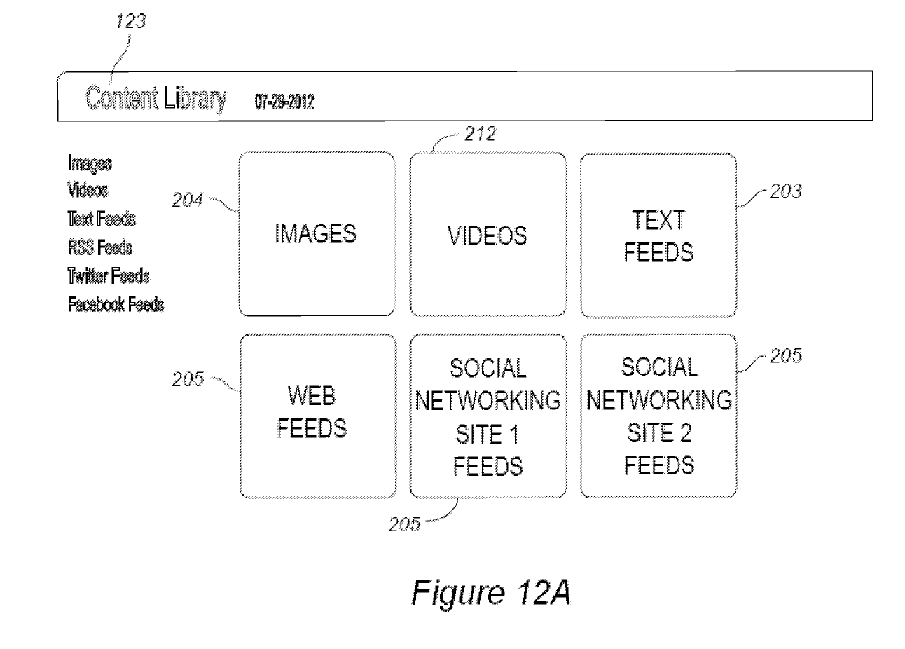

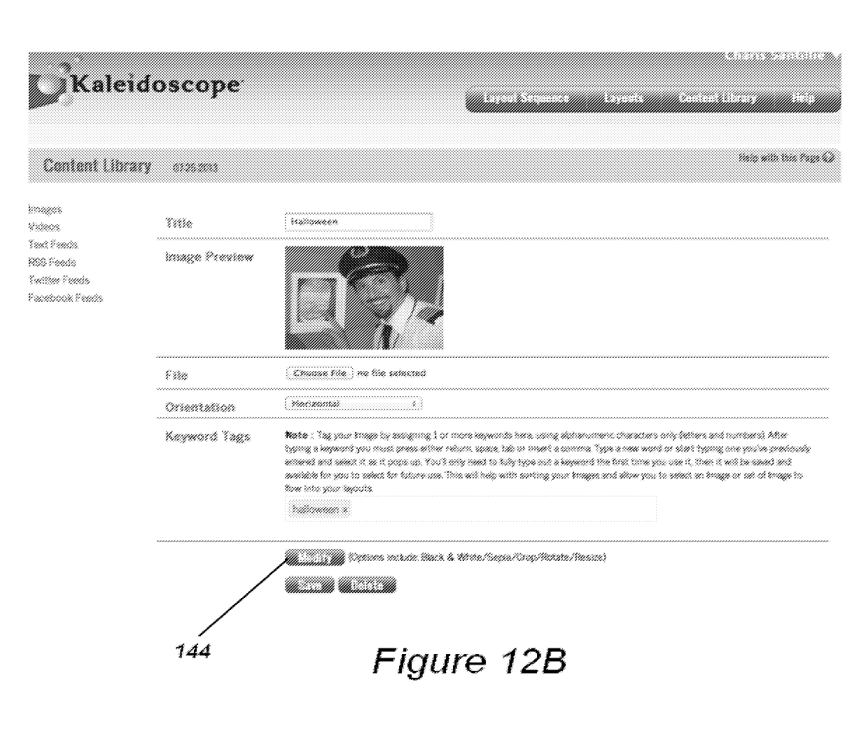

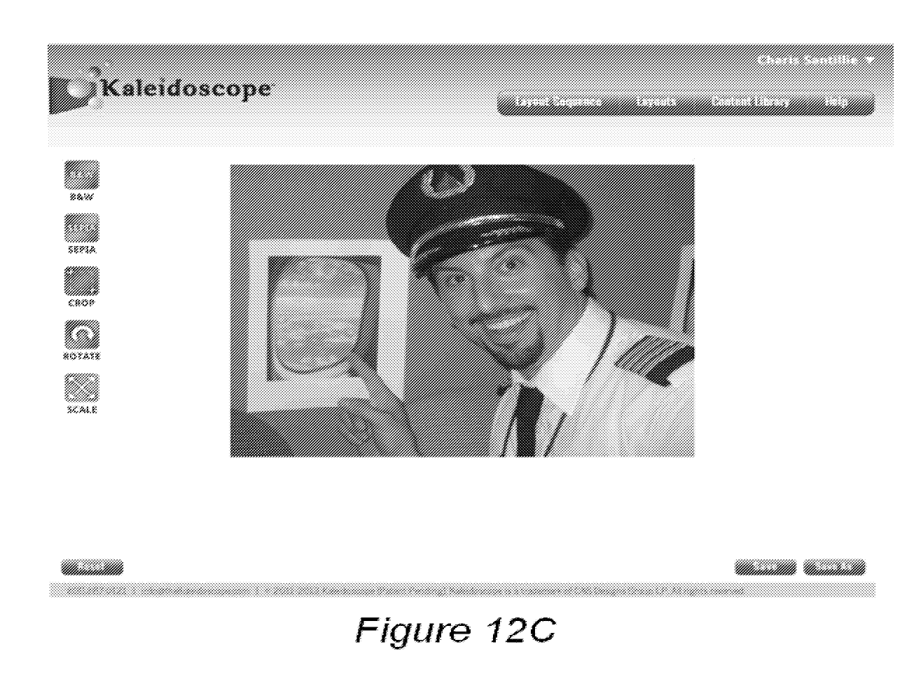

FIG. 12A illustrates the various content media library of the digital signage system that is populated with various files and file types that can be assigned to the modules of the layout. Several examples are provided, included but not limited to image 204, video 212, text feeds 203, web feed 205 and social networking content 205 that can be assigned to digital signage presentations of the invention.

FIGS. 12B and 12C illustrate the ability to edit and modify an image from within the content library. That is, a user can edit and modify their own image that they upload to the content library from within the application. By clicking on the “Modify” button 144 of the edit image screen shown in FIG. 12B the user is taken to a modify image screen where the user has the options to change the image color and lighting to black/white or sepia, to crop the image, to rotate the image, to scale the image, or to remove red eyes, for example, and among other functionalities commonly known in the art of image modification and editing.

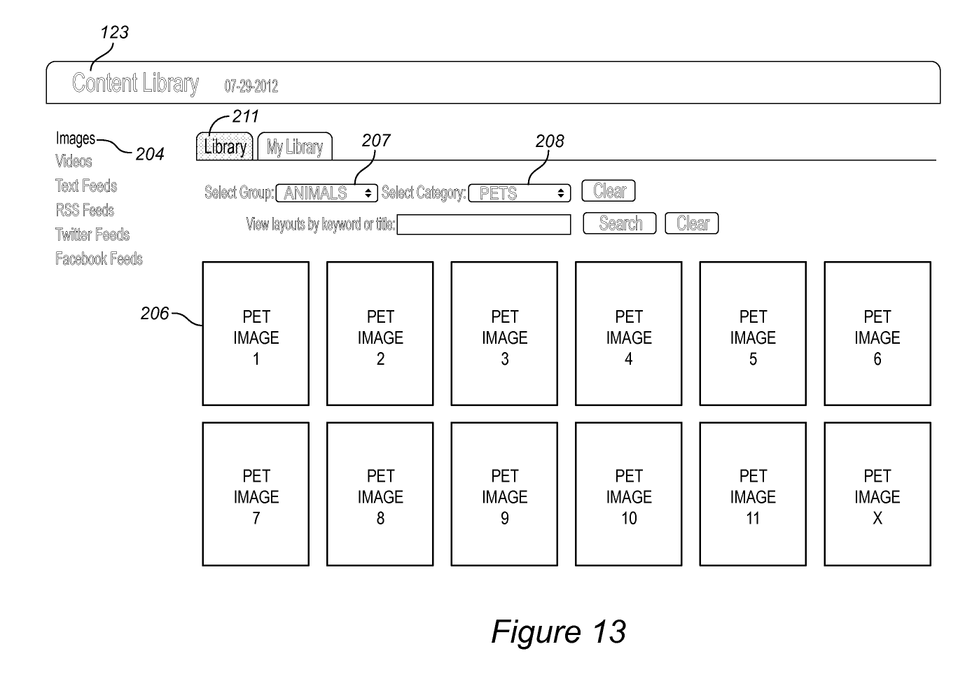

FIG. 13 illustrates the content library section of the digital signage system of the invention 123. As shown, a library tab 211 can be selected by a user to provide several media files that the user can select for assignment into a digital signage presentation. Media content is organized according to category of the content 208 (i.e., pets, etc.), module types 204 and group 207 depending on the needs of the user creating the digital signage.

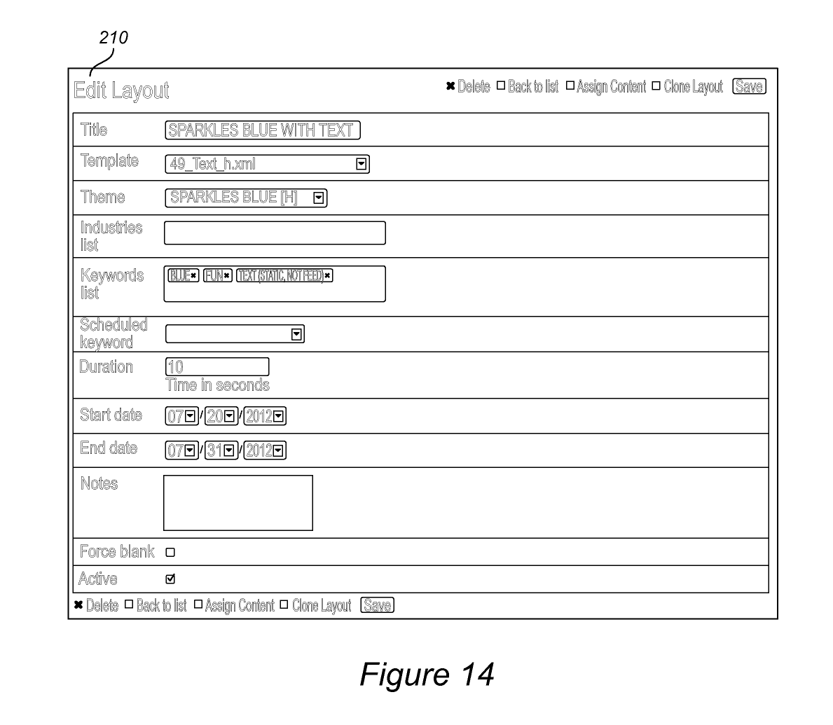

FIG. 14 illustrates the ability of an administrative user to edit a layout according to the needs and desires of the user 210. As provided, the layout can be assigned a title, a template as well as a theme. Start and end dates of displaying the layout are also available for editing by the administrative user, as well as other aspects of the layout display.

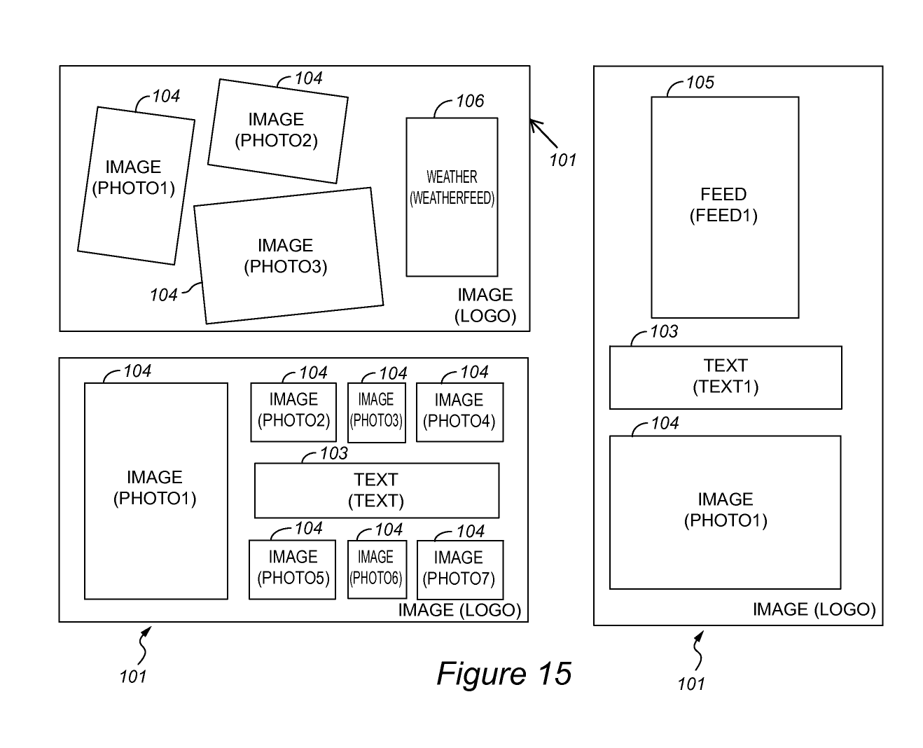

FIG. 15 illustrates a layout prepared and assigned with media content 101. As shown, a section 101 of the layout is populated with modules related to image files 104 and weather feed Internet files 106. In another section 101 image 104 and text 103 files are combined with online feed files 105. In yet another section of the layout 101, image and text files are assigned content media.

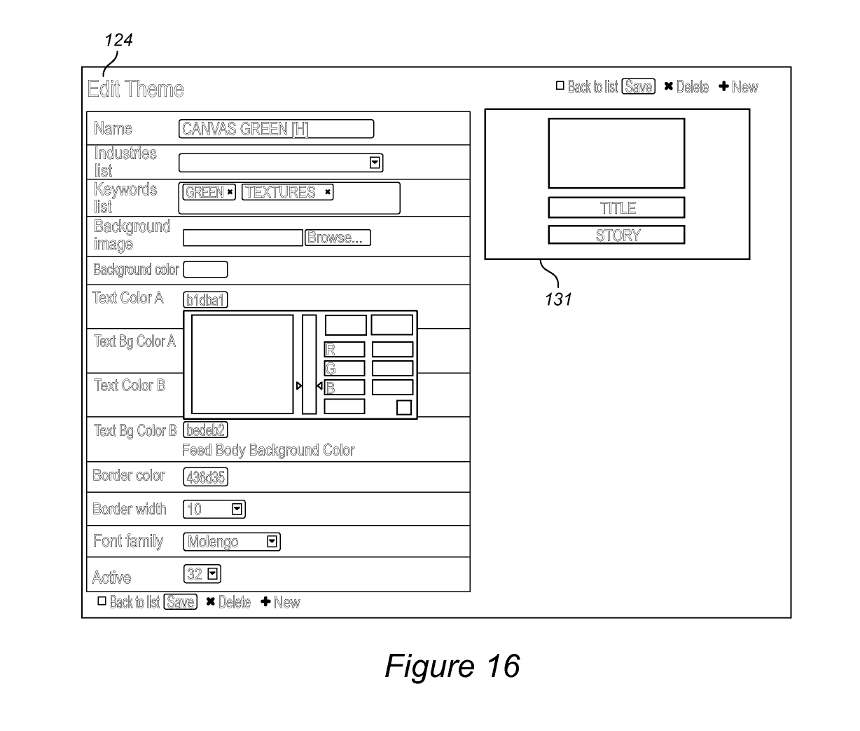

FIG. 16 illustrates the ability of an administrative user to edit a theme of the invention 124. As provided, themes can be edited in various characteristics including but not limited to name, industry type, title, text and border colors and font. Once a theme is edited, it can be saved and added to a template to form a layout that can then be edited and customized according to an administrative user's needs. In the Custom layouts tab of the client user interface, the client user can create a custom layout by assigning a particular theme to a particular template.

The present invention is directed to a system and methods that allow a user subscriber to create customized digital signage advertising and marketing presentations utilizing a user-friendly user interface in which user subscribers access a database of information including for example, starting templates, generic, “stock” layouts, media content, as well as other aspects of creating the digital signage. The Applicant administrators create stock templates and layouts and other aspects of a layout presentation which is accessed by the user subscriber in order to create a desired, customized digital signage presentation.

Advantages of the present invention over that known in the art include the ability to schedule layouts according to the user subscriber's desired intentions. Further, the present invention allows a user subscriber to access and view a previously prepared content library so that a user subscriber can carefully select content to be included in a new digital signage layout sequence presentation. In addition, the invention allows customer users to upload and/or create their own media content to be displayed in the layout/layout sequence. Other advantages include an easy to use, user-interface on which the user can access different media content files, situated and stored in a content library provided by the administrative user for use in preparing digital signage presentations. Other advantages include the ability of a user to access pre-made, “stock” templates and layouts that can be edited and customized for purposes of a particular user's needs. Still, another advantage of the present invention is the ability for a user to schedule layouts according to a particular time range such as for an event or holiday related season. Also included with this advantage is the ability for a user to schedule particular layouts to display in sequence according to customized needs of the user's business.

Although the invention has been described with reference to the above description, it will be understood that modifications and variations are encompassed within the spirit and scope of the invention. Accordingly, the invention is limited only by the following claims.

What is claimed is:

1. A system for preparing and managing digital presentations comprising:
a. a server;
b. a customer user interface and an administrative user interface, a processor and memory;
c. wherein the server stores media content and layouts and is programmed to:
i. receive customer user input via an internet, web-based connection, to customize layouts in order to create digital signage presentations with the customer user having access to said layouts created by administrative users, the layouts being editable by the customer user according to the needs of the particular customer;
ii. wherein the layouts contain one or more modules which display media content files assigned by either an administrative or customer user;
iii. the layouts being editable to be added to other layouts to form layout sequences;
iv. the layout sequences displaying each layout in turn according to the order of the layouts assigned by the customer user, wherein the layouts are displayed on a video display device.

2. The system of claim 1 wherein the layout sequences are assigned by a user to display at particular times of the day, week, month or year.

3. The system of claim 2 wherein the duration of a particular layout can be assigned by a customer user or by an administrative user.

4. The system of claim 3 in which modules can be assigned content media stored on the server within a content library.

5. The system of claim 4 in which content media files are text, video, web feed or images files.

6. The system of claim 4 wherein the customer user uploads custom media content to the content library.

7. The system of claim 6 wherein the customer user assigns content media from the content library to a module.

8. The system of claim 7 wherein a customer user can arrange the appearance of layouts contained in a layout sequence into a desired sequence via the customer user interface.

9. The system of claim 8 wherein the customer can add or delete layouts contained in said layout sequence.

10. The system of claim 9 wherein a customer user can filter content files according to a desired category.

11. The system of claim 10 wherein a customer is able to preview edits made to a layout prior to incorporation into a layout sequence.

12. The system of claim 1 wherein a customer user selects a layout from a variety of layouts according to the customer user's desires.

13. The layout of claim 12 wherein the layout is preset, pending or blank.

14. The blank layout of claim 13 wherein the customer user populates modules by assigning content media to said modules.

15. The preset layout of claim 13 wherein the customer user edits the layout's modules with content uploaded from the content library.

16. The preset of layout of claim 15 wherein the uploaded content comprises text, video, image or web feed files.

17. The layout of claim 1 wherein the layout is comprised of a template (XML file) and a theme.

18. The layout of claim 17 wherein an administrative user assigns attributes to the layout including title, template, theme, industry, start and end date and key words.

19. The layout of claim 18 wherein an administrative user assigns attributes to the template (XML file) including orientation, shape, angle, module type and coordinates of the layout.

20. A method of creating and managing digital presentations comprising:
a. receiving customer user input via an internet, web-based connection, to customize one or more layouts in order to create and edit digital signage presentations with a customer user having access to said layouts created by administrative users, the layouts being editable by the customer user according to the needs of the particular customer.
